(19) United States
(12) Patent Application Publication
(10) Pub. No.: US 2024/0378458 A1
(43) Pub. Date: Nov. 14, 2024

(54) METHOD FOR ASCERTAINING AN OPTIMAL ARCHITECTURE OF AN ARTIFICIAL NEURAL NETWORK

(71) Applicant: Robert Bosch GmbH, Stuttgart (DE)

(72) Inventors: Jan Hendrik Metzen, Boeblingen (DE); Benedikt Sebastian Staffler, Tuebingen (DE); Melanie Jehn, Darmstadt (DE)

(21) Appl. No.: 18/657,869

(22) Filed: May 8, 2024

(30) Foreign Application Priority Data
May 10, 2023 (DE) 10 2023 204 300.9

(51) Int. Cl. G06N 3/0985; G06N 3/042

(52) U.S. Cl. CPC G06N 3/0985; G06N 3/042

(57) ABSTRACT

A method for ascertaining an optimal architecture of an artificial neural network. The method includes: respectively ascertaining, for each of at least two specifications for ascertaining the architecture, an optimal architecture with respect to the corresponding specification by associating a flow with each edge of a directed graph, and respectively updating the flows associated with the edges along the trajectory, based on the cost function, wherein the steps are repeated until an ascertained trajectory fulfills a termination criterion for the architecture search, and wherein the trajectory fulfilling the termination criterion represents the optimal architecture; and ascertaining the optimal architecture of the artificial neural network based on the respective optimal architectures with respect to each of the at least two specifications.

### CROSS REFERENCE

The present application claims the benefit under 35 U.S.C. § 119 of German Patent Application No. DE 10 2023 204 300.9 filed on May 10, 2023, which is expressly incorporated herein by reference in its entirety.

### FIELD

The present invention relates to a method for ascertaining an optimal architecture of an artificial neural network, in particular a method for ascertaining an optimal architecture of an artificial neural network in terms of a plurality of criteria, by means of which resources can be saved when ascertaining the optimal architecture, and by means of which the accuracy in ascertaining the optimal architecture can also be increased at the same time.

### BACKGROUND INFORMATION

Machine learning algorithms are based on using statistical methods to train a data processing system in such a way that it can perform a particular task without it being originally programmed explicitly for this purpose. The goal of machine learning is to construct algorithms that can learn and make predictions from data. These algorithms create mathematical models by means of which data can be classified, for example.

An example of such machine learning algorithms are artificial neural networks. Such artificial neural networks are patterned after biological neurons and allow learning an unknown system behavior from existing training data and subsequently applying the learned system behavior even to unknown input variables. The neural network consists of layers having idealized neurons, which are connected to one another in different ways in accordance with a topology of the network. The first layer, which is also referred to as an input layer, detects and transmits the input values, the number of neurons in the input layer corresponding to the number of input signals which are to be processed. The last layer is also referred to as an output layer and has just as many neurons as output values to be provided. In addition, at least one intermediate layer, which is often also referred to as the hidden layer, is located between the input layer and the output layer, wherein the number of intermediate layers and the number and/or type of neurons in these layers depend on the specific task to be achieved by the neural network.

However, the development of the architecture of the artificial neural network, i.e., the determination of the appearance of the network or of the number of layers in the network as well as the determination of the number and/or type of neurons in the individual layers, is usually very complex, in particular with regard to the consumption of resources. In order to optimize the development of the architecture, the neural architecture search (NAS) was developed, which develops optimal architectures for specific problems in an automated manner. The NAS algorithm first assembles an architecture for the artificial neural network from various modules and configurations, which architecture is subsequently trained with a set of training data, and wherein obtained results are subsequently evaluated with regard to performance. Based on this assessment, a new architecture that is expected to be more optimal with regard to performance can subsequently be ascertained, which architecture is subsequently again trained based on the training data, and wherein the obtained results are subsequently again evaluated with regard to performance. These steps can be repeated as many times as necessary until changes in the architecture no longer achieve improvement, wherein gradient-based methods are usually used to ascertain the more optimal architecture.

In particular, the performance of an artificial neural network depends inter alia on the architecture selected. However, it proves disadvantageous that it is usually difficult to determine an actually optimal architecture for the artificial neural network, wherein the determination of the optimal architecture is nevertheless usually associated with high consumption of resources. If a plurality of specifications, or conditions, or criteria are to be taken into account when determining the optimal architecture, it is usually also necessary to completely reascertain the optimal architecture if the specifications change or other criteria are to be taken into account.

A method for creating an artificial neural network is described in German Patent Application No. DE 10 2019 214 625 A1. The method comprises providing a plurality of different data sets, initializing a plurality of hyperparameters, training the artificial neural network, evaluating the trained artificial neural network, optimizing the hyperparameters depending on the evaluation, and retraining the artificial neural network using the optimized hyperparameters.

An object of the present invention it to specify an improved method for ascertaining an optimal architecture for an artificial neural network.

The object may be achieved by a method for ascertaining an optimal architecture of an artificial neural network according to features of the present invention.

The object may be achieved by a system for ascertaining an optimal architecture of an artificial neural network according to features of present invention.

### SUMMARY

According to one example embodiment of the present invention, this object may be achieved by a method for ascertaining an optimal architecture of an artificial neural network, wherein the method comprises providing a set of possible architectures of the artificial neural network; representing the set of possible architectures of the artificial neural network in a directed graph, wherein the nodes of the directed graph respectively symbolize a subset of one of the possible architectures, wherein an initial node symbolizes an input layer, wherein terminal nodes of the directed graph respectively symbolize a subset comprising an output layer, and wherein the edges of the directed graph symbolize possible links between the subsets; respectively ascertaining, for each of at least two specifications for ascertaining the architecture, an optimal architecture with respect to the corresponding specification by respectively associating a flow with each edge of the directed graph, defining a strategy for ascertaining a corresponding optimal architecture based on the directed graph, and ascertaining the corresponding optimal architecture by repeatedly ascertaining a trajectory from the initial node to a terminal node based on the defined strategy, determining a reward for the ascertained trajectory, determining a cost function for the ascertained trajectory based on the ascertained reward for the trajectory and the flows associated with the edges along the trajectory, and respectively updating the flows associated with the edges along the trajectory, based on the cost function, wherein the steps of ascertaining a trajectory, of determining a reward, of determining a cost function, and of updating the flows are repeated until an ascertained trajectory fulfills a termination criterion for the architecture search, and wherein the trajectory that fulfills the termination criterion represents the optimal architecture. The method furthermore comprises ascertaining the optimal architecture of the artificial neural network based on the respective optimal architectures with respect to each of the at least two specifications or the previously ascertained optimal architectures with respect to all of the at least two specifications, and providing the optimal architecture of the artificial neural network.

A set of possible architectures is understood to mean a plurality of possible architectures of the artificial neural network or a corresponding search space.

A directed graph is moreover a graph comprising nodes and edges connecting individual nodes, wherein the edges are directed edges, i.e., edges that can only be passed through in one direction.

Each node of the directed graph symbolizing a subset of one of the possible architectures means that each node symbolizes a subset of at least one of the possible architectures of the artificial neural network, wherein each node can symbolize a different subset, and wherein the subsets can be distributed among the individual nodes of the directed graph such that, overall, all possible architectures of the artificial neural network are included or represented in the directed graph. The subsets respectively comprise or denote at least one layer of the corresponding possible architecture.

A strategy for ascertaining an optimal architecture based on the directed graph is furthermore understood to mean a plan based on which individual nodes of the directed graph are selected based on the corresponding specification or the corresponding criterion in order to obtain the trajectory.

In particular, a continuous path between the initial node and one of the terminal nodes is referred to as a trajectory.

A reward is furthermore understood to mean a value, determinable by evaluating the architecture representing the corresponding trajectory, of an improvement achievable by the corresponding architecture.

Furthermore, a cost function or loss is understood to mean a loss or an error between a reward, expected based on the flows associated with the edges along the trajectory, for the ascertained trajectory and the determined actual reward for the trajectory.

A termination criterion for the architecture search is moreover specified as a predefined criterion, wherein the ascertainment of the corresponding optimal architecture is terminated if an ascertained architecture or an architecture represented by an ascertained trajectory fulfills the termination criterion with respect to the corresponding specification or the corresponding criterion.

The architecture being represented by the ascertained trajectory means that the architecture is formed by correspondingly linking the subsets symbolized by the nodes along the ascertained trajectory.

The method according to the present invention thus differs from conventional customary methods for ascertaining an optimal architecture of an artificial neural network in that not the reward itself is optimized, but potential architectures are respectively checked or examined based on the rewards associated with these architectures. In addition, the method according to the present invention differs from customary methods for ascertaining an optimal architecture of an artificial neural network in that gradients for determining a more optimal architecture are not estimated, for example, but flows or values associated with the individual edges of the directed graph or associations between subsets of the possible architectures of the artificial neural network are optimized and adapted to the actual circumstances.

An advantage of not optimizing the reward itself but of respectively checking or examining potential architectures based on the rewards associated with these architectures is that the accuracy in ascertaining the optimal architecture and in particular also the probability of finding the actually optimal architecture can be increased.

In addition, the advantage of not estimating gradients but of optimizing flows or values associated with the individual edges of the directed graph or associations between subsets of the possible architectures of the artificial neural network and adapting them to the actual circumstances is that this is, for example, less susceptible to noise and overall requires fewer iterations to ascertain the optimal architecture, by means of which resources required to ascertain the optimal architecture, for example memory and/or processor capacities, can be saved.

The optimal architecture of the artificial neural network also being ascertained based on previously determined architectures, which are each optimal in terms of a specification to be taken into account when determining the optimal specification, also has the advantage that the optimal architecture of the artificial neural network does not have to be completely reascertained in a complex and resource-intensive manner if the specifications are weighted differently or other criteria are to be taken into account.

Overall, an improved method for ascertaining an optimal architecture for an artificial neural network is thus specified.

In one example embodiment of the present invention, the step of ascertaining an optimal architecture of the artificial neural network based on the respective optimal architectures with respect to each of the at least two specifications comprises a weighted summation of the optimal architectures with respect to the at least two specifications.

The optimal architectures being summed up means that the rewards respectively corresponding to the corresponding optimal architectures and the optimal flows respectively corresponding to the corresponding optimal architectures are summed up, wherein the optimal architecture of the artificial neural network is ascertained based on the sum of the individual optimal flows.

Weighting is furthermore understood to mean the assessment of individual influencing variables of a mathematical model, for example in terms of their significance. Weighted summation means that the individual summands, i.e., the individual optimal flows, are weighted based on their significance or importance.

The optimal architecture of the artificial neural network can thus be ascertained in a simple way based on the individual optimal architectures in terms of the at least two specifications, without the need for complex and resource-intensive adaptations.

A corresponding weighting can be based on the current hardware conditions of at least one target component.

Hardware conditions of the at least one target component are furthermore understood to mean items of information about the resources available, in particular for the use of the artificial neural network, of the at least one target component, for example memory and/or processor capacities.

Conditions of the data processing system on which the correspondingly trained artificial neural network is subsequently used are thus taken into account in ascertaining the optimal architecture of the artificial neural network.

In one example embodiment of the present invention, the reward for the trajectory is determined based also on hardware conditions of at least one target component.

Conditions of the data processing system on which the correspondingly trained artificial neural network is subsequently used are thereby likewise taken into account in ascertaining the optimal architecture of the artificial neural network.

With a further embodiment of the present invention, a method for training an artificial neural network is also specified, wherein the method comprises providing training data for training the artificial neural network; providing an optimal architecture for the artificial neural network, wherein the optimal architecture of the artificial neural network has been ascertained by a method described above for ascertaining an optimal architecture of an artificial neural network; and training the artificial neural network based on the training data and the optimal architecture.

According to an example embodiment of the present invention, a method for training an artificial neural network is thus specified, which method is based on an optimal architecture ascertained by an improved method for ascertaining an optimal architecture for an artificial neural network. The advantage of not optimizing the reward itself but of respectively checking or examining potential architectures based on the rewards associated with these architectures is that the accuracy in ascertaining the optimal architecture and in particular also the probability of finding the actually optimal architecture can be increased. In addition, the advantage of not estimating gradients but of optimizing flows or values associated with the individual edges of the directed graph or associations between subsets of the possible architectures of the artificial neural network and adapting them to the actual circumstances is that this is, for example, less susceptible to noise and overall requires fewer iterations to ascertain the optimal architecture, by means of which resources required to ascertain the optimal architecture, for example memory and/or processor capacities, can be saved. The optimal architecture of the artificial neural network also being ascertained based on previously determined architectures, which are each optimal in terms of a specification to be taken into account when determining the optimal specification, also has the advantage that the optimal architecture of the artificial neural network does not have to be completely reascertained in a complex and resource-intensive manner if the specifications are weighted differently or other criteria are to be taken into account.

The training data can comprise sensor data.

A sensor, which is also referred to as a detector, (measured variable or measuring) pickup or (measuring) probe, is a technical component which can detect certain physical or chemical properties and/or the material nature of its surroundings qualitatively or quantitatively as a measured variable.

Circumstances outside of the actual data processing system on which the method is performed can thus be captured in a simple manner and taken into account in the training of the artificial neural network.

With a further example embodiment of the present invention, a method for controlling a controllable system based on an artificial neural network is furthermore also specified, wherein the method comprises providing an artificial neural network which is trained to control the controllable system, wherein the artificial neural network has been trained by a method described above for training an artificial neural network; and controlling the controllable system based on the provided artificial neural network.

The controllable system can, in particular, be a robotic system, wherein the robotic system can, for example, be an embedded system of a motor vehicle and/or a motor vehicle function.

A method for controlling a controllable system based on an artificial neural network is thus specified, wherein the artificial neural network is based on an optimal architecture ascertained by an improved method for ascertaining an optimal architecture for an artificial neural network. The advantage of not optimizing the reward itself but of respectively checking or examining potential architectures based on the rewards associated with these architectures is that the accuracy in ascertaining the optimal architecture and in particular also the probability of finding the actually optimal architecture can be increased. In addition, the advantage of not estimating gradients but of optimizing flows or values associated with the individual edges of the directed graph or associations between subsets of the possible architectures of the artificial neural network and adapting them to the actual circumstances is that this is, for example, less susceptible to noise and overall requires fewer iterations to ascertain the optimal architecture, by means of which resources required to ascertain the optimal architecture, for example memory and/or processor capacities, can be saved. The optimal architecture of the artificial neural network also being ascertained based on previously determined architectures, which are each optimal in terms of a specification to be taken into account when determining the optimal specification, also has the advantage that the optimal architecture of the artificial neural network does not have to be completely reascertained in a complex and resource-intensive manner if the specifications are weighted differently or other criteria are to be taken into account.

With a further example embodiment of the present invention, a system for ascertaining an optimal architecture of an artificial neural network is moreover also specified, wherein the system comprises a first provision unit designed to provide a set of possible architectures of the artificial neural network; a representation unit designed to represent the set of possible architectures of the artificial neural network in a directed graph, wherein the nodes of the directed graph respectively symbolize a subset of one of the possible architectures, wherein an initial node symbolizes an input layer, wherein terminal nodes of the directed graph respectively symbolize a subset comprising an output layer, and wherein the edges of the directed graph respectively symbolize possible links between the subsets; at least one first ascertainment unit designed to respectively ascertain, for each of at least two specifications for ascertaining the architecture, an optimal architecture with respect to the corresponding specification by respectively associating a flow with each edge of the directed graph, defining a strategy for ascertaining a corresponding optimal architecture based on the directed graph, and ascertaining the corresponding optimal architecture by repeatedly ascertaining a trajectory from the initial node to a terminal node based on the defined strategy, determining a reward for the ascertained trajectory, determining a cost function for the ascertained trajectory based on the ascertained reward for the trajectory and the flows associated with the edges along the trajectory, and respectively updating the flows associated with the edges along the trajectory, based on the cost function, wherein the steps of ascertaining a trajectory, of determining a reward, of determining a cost function, and of updating the flows are repeated until an ascertained trajectory fulfills a termination criterion for the architecture search, and wherein the trajectory that fulfills the termination criterion represents the optimal architecture. Furthermore, the system comprises a second ascertainment unit designed to ascertain the optimal architecture of the artificial neural network based on the respective ascertained optimal architectures with respect to each of the at least two specifications, and a second provision unit designed to provide the optimal architecture of the artificial neural network.

An improved system for ascertaining an optimal architecture for an artificial neural network is thus specified. An advantage of not optimizing the reward itself but of respectively checking or examining potential architectures based on the rewards associated with these architectures is that the accuracy in ascertaining the optimal architecture and in particular also the probability of finding the actually optimal architecture can be increased. In addition, the advantage of not estimating gradients but of optimizing flows or values associated with the individual edges of the directed graph or associations between subsets of the possible architectures of the artificial neural network and adapting them to the actual circumstances is that this is, for example, less susceptible to noise and overall requires fewer iterations to ascertain the optimal architecture, by means of which resources required to ascertain the optimal architecture, for example memory and/or processor capacities, can be saved. The optimal architecture of the artificial neural network also being ascertained based on previously determined architectures, which are each optimal in terms of a specification to be taken into account when determining the optimal specification, also has the advantage that the optimal architecture of the artificial neural network does not have to be completely reascertained in a complex and resource-intensive manner if the specifications are weighted differently or other criteria are to be taken into account.

In one example embodiment of the present invention, the second ascertainment unit is designed to ascertain the optimal architecture of the artificial neural network by weighted summation of the respective optimal architectures with respect to each of the at least two specifications. The optimal architecture of the artificial neural network can thus be ascertained in a simple way based on the individual optimal architectures in terms of the at least two specifications, without the need for complex and resource-intensive adaptations.

A corresponding weighting can be based on the current hardware conditions of at least one target component. Conditions of the data processing system on which the correspondingly trained artificial neural network is subsequently used are thus taken into account in ascertaining the optimal architecture of the artificial neural network.

In one example embodiment of the present invention, the first ascertainment unit is moreover designed to determine the reward for the trajectory based on hardware conditions of at least one target component. Conditions of the data processing system on which the correspondingly trained artificial neural network is subsequently used are thus again taken into account in ascertaining the optimal architecture of the artificial neural network.

With a further example embodiment of the present invention, a system for training an artificial neural network is moreover also specified, wherein the system comprises a first provision unit designed to provide training data for training the artificial neural network; a second provision unit designed to provide an optimal architecture for the artificial neural network, wherein the optimal architecture has been ascertained by a system described above for ascertaining an optimal architecture for an artificial neural network; and a training unit designed to train the artificial neural network based on the training data and the optimal architecture.

A system for training an artificial neural network is thus specified, which system is based on an optimal architecture ascertained by an improved system for ascertaining an optimal architecture for an artificial neural network. The advantage of not optimizing the reward itself but of respectively checking or examining potential architectures based on the rewards associated with these architectures is that the accuracy in ascertaining the optimal architecture and in particular also the probability of finding the actually optimal architecture can be increased. In addition, the advantage of not estimating gradients but of optimizing flows or values associated with the individual edges of the directed graph or associations between subsets of the possible architectures of the artificial neural network and adapting them to the actual circumstances is that this is, for example, less susceptible to noise and overall requires fewer iterations to ascertain the optimal architecture, by means of which resources required to ascertain the optimal architecture, for example memory and/or processor capacities, can be saved. The optimal architecture of the artificial neural network also being ascertained based on previously determined architectures, which are each optimal in terms of a specification to be taken into account when determining the optimal specification, also has the advantage that the optimal architecture of the artificial neural network does not have to be completely reascertained in a complex and resource-intensive manner if the specifications are weighted differently or other criteria are to be taken into account.

The training data can again comprise sensor data. Circumstances outside of the actual data processing system on which the method is performed can thus be captured in a simple manner and taken into account in the training of the artificial neural network.

With a further example embodiment of the present invention, a system for controlling a controllable system based on an artificial neural network is moreover also specified, wherein the system comprises a provision unit designed to provide an artificial neural network which is trained to control the controllable system, wherein the artificial neural network has been trained by a system described above for training an artificial neural network; and a control unit designed to control the controllable system based on the provided artificial neural network.

A system for controlling a controllable system based on an artificial neural network is thus specified, wherein the artificial neural network is based on an optimal architecture ascertained by an improved system for ascertaining an optimal architecture for an artificial neural network. The advantage of not optimizing the reward itself but of respectively checking or examining potential architectures based on the rewards associated with these architectures is that the accuracy in ascertaining the optimal architecture and in particular also the probability of finding the actually optimal architecture can be increased. In addition, the advantage of not estimating gradients but of optimizing flows or values associated with the individual edges of the directed graph or associations between subsets of the possible architectures of the artificial neural network and adapting them to the actual circumstances is that this is, for example, less susceptible to noise and overall requires fewer iterations to ascertain the optimal architecture, by means of which resources required to ascertain the optimal architecture, for example memory and/or processor capacities, can be saved. The optimal architecture of the artificial neural network also being ascertained based on previously determined architectures, which are each optimal in terms of a specification to be taken into account when determining the optimal specification, also has the advantage that the optimal architecture of the artificial neural network does not have to be completely reascertained in a complex and resource-intensive manner if the specifications are weighted differently or other criteria are to be taken into account.

With a further example embodiment of the present invention, a computer program having program code is furthermore also specified for performing a method described above for ascertaining an optimal architecture of an artificial neural network when the computer program is executed on a computer.

The computer program has the advantage of being designed to perform an improved method for ascertaining an optimal architecture for an artificial neural network. The advantage of not optimizing the reward itself but of respectively checking or examining potential architectures based on the rewards associated with these architectures is that the accuracy in ascertaining the optimal architecture and in particular also the probability of finding the actually optimal architecture can be increased. In addition, the advantage of not estimating gradients but of optimizing flows or values associated with the individual edges of the directed graph or associations between subsets of the possible architectures of the artificial neural network and adapting them to the actual circumstances is that this is, for example, less susceptible to noise and overall requires fewer iterations to ascertain the optimal architecture, by means of which resources required to ascertain the optimal architecture, for example memory and/or processor capacities, can be saved. The optimal architecture of the artificial neural network also being ascertained based on previously determined architectures, which are each optimal in terms of a specification to be taken into account when determining the optimal specification, also has the advantage that the optimal architecture of the artificial neural network does not have to be completely reascertained in a complex and resource-intensive manner if the specifications are weighted differently or other criteria are to be taken into account.

In summary, it should be noted that the present invention specifies a method for ascertaining an optimal architecture of an artificial neural network, in particular a method for ascertaining an optimal architecture of an artificial neural network in terms of a plurality of criteria, by means of which resources can be saved when ascertaining the optimal architecture, and by means of which the accuracy in ascertaining the optimal architecture can also be increased at the same time.

The described example embodiments and developments of the present invention can be combined with one another as desired.

Further possible embodiments, developments and implementations of the present invention also include not explicitly mentioned combinations of features of the present invention described above or below with respect to exemplary embodiments.

### BRIEF DESCRIPTION OF THE DRAWINGS

The figures are intended to impart further understanding of the example embodiments of the present invention. They illustrate example embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a flowchart of a method for ascertaining an optimal architecture of an artificial neural network according to embodiments of the present invention.

FIG. 2 is a schematic block diagram of a system for ascertaining an optimal architecture of an artificial neural network according to embodiments of the present invention.

### DETAILED DESCRIPTION OF EXAMPLE EMBODIMENTS

In the figures, identical reference signs denote identical or functionally identical elements, parts or components, unless stated otherwise.

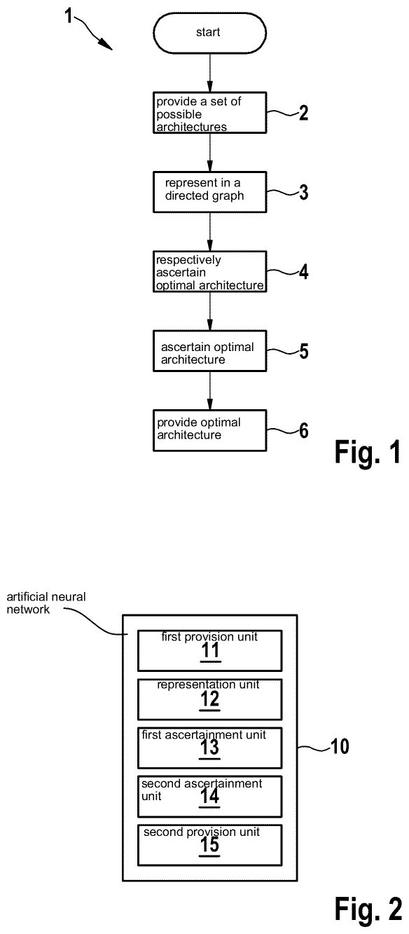

FIG. 1 shows a flowchart of a method for ascertaining an optimal architecture of an artificial neural network 1 according to embodiments of the present invention.

A neural architecture search (NAS) is generally understood to mean a method for the automated development of an optimal architecture of artificial neural networks for a specified problem. This eliminates the elaborate, manual design of artificial neural networks and is a subarea of automated machine learning.

Scalable neural architecture search methods are gradient-based methods. In this case, a supergraph is formed from all possible architectures, contained in a search space, for the artificial neural network, wherein the individual possible architectures are subgraphs of the supergraph. The nodes of the supergraph respectively symbolize a subset of one of the possible architectures, wherein a node can respectively, in particular, symbolize exactly one possible layer of the artificial neural network, wherein an initial node symbolizes an input layer of the artificial neural network, wherein terminal nodes of the directed graph respectively symbolize a subset of one of the possible architectures, which comprises an output layer, and wherein the edges symbolize possible links between the subsets, wherein each edge is respectively associated with a parameter based on a strategy for selecting nodes. Furthermore, attempts are made to use the supergraph as the basis for finding an architecture for which a reward or a yield is maximum, wherein a gradient descent method is used to determine the optimal architecture for the artificial neural network. In the case of multi-criteria tasks, or neural networks that are to fulfill a plurality of tasks, an attempt is usually made to ascertain an optimal architecture based on a common strategy that should cover all criteria.

FIG. 1 shows a method 1 comprising a step 2 of providing a set of possible architectures of the artificial neural network, or a corresponding search space; a step 3 of representing the set of possible architectures of the artificial neural network in a directed graph, wherein the nodes of the directed graph respectively symbolize a subset of one of the possible architectures, wherein an initial node symbolizes an input layer, wherein terminal nodes of the directed graph respectively symbolize a subset comprising an output layer, and wherein the edges of the directed graph symbolize possible links between the subsets; a step 4 of respectively ascertaining, for each of at least two specifications for ascertaining the architecture, an optimal architecture in terms of the corresponding specification by associating a flow with each edge of the directed graph, defining a strategy for ascertaining a corresponding optimal architecture based on the directed graph, and ascertaining the corresponding optimal architecture by repeatedly ascertaining a trajectory from the initial node to a terminal node based on the defined strategy, determining a reward for the ascertained trajectory, determining a cost function for the ascertained trajectory based on the ascertained reward for the trajectory and the flows associated with the edges along the trajectory, and respectively updating the flows associated with the edges along the trajectory, based on the cost function, wherein the steps of ascertaining a trajectory, of determining a reward, of determining a cost function, and of updating the flows are repeated until an ascertained trajectory fulfills a termination criterion for the architecture search, and wherein the trajectory that fulfills the termination criterion represents the optimal architecture. Furthermore, the method 1 comprises a step 5 of ascertaining the optimal architecture of the artificial neural network based on the respective optimal architectures with respect to each of the at least two specifications, and a step 6 of providing the optimal architecture of the artificial neural network.

The advantage of not optimizing the reward itself but of respectively checking or examining potential architectures based on the rewards associated with these architectures is that the accuracy in ascertaining the optimal architecture and in particular also the probability of finding the actually optimal architecture can be increased.

In addition, the advantage of not estimating gradients but of optimizing flows or values associated with the individual edges of the directed graph or associations between subsets of the possible architectures of the artificial neural network and adapting them to the actual circumstances is that this is, for example, less susceptible to noise and overall requires fewer iterations to ascertain the optimal architecture, by means of which resources required to ascertain the optimal architecture, for example memory and/or processor capacities, can be saved.

The optimal architecture of the artificial neural network also being ascertained based on previously determined architectures, which are each optimal in terms of a specification to be taken into account when determining the optimal specification, also has the advantage that the optimal architecture of the artificial neural network does not have to be completely reascertained in a complex and resource-intensive manner if the specifications are weighted differently or other criteria are to be taken into account.

Overall, an improved method for ascertaining an optimal architecture for an artificial neural network 1 is thus specified.

In particular, FIG. 1 shows a method 1 which is based on the application of flow methods instead of a gradient-based approach, in particular in order to ascertain an optimal architecture for a neural network that performs a plurality of tasks simultaneously. The desired architecture can in this case be ascertained with regard to its performance with respect to a plurality of tasks to be performed by the corresponding neural network.

According to the present invention, the at least two specifications include hardware metrics, in particular desired latencies, an energy consumption and/or currently available resources. Additionally, the at least two specifications can also include reception tasks, for example detection accuracies or a type of detection.

The set of possible architectures and thus also the directed graph or supergraph can be based on labeled training data, for example labeled sensor data for training the artificial neural network.

According to the embodiments of FIG. 1, each node in the directed graph furthermore symbolizes exactly one possible layer of the artificial neural network. Based on the method 1 shown, the corresponding architecture for each of the at least two specifications can respectively in particular be constructed sequentially, i.e., each layer can be selected individually, or it can in each case be ascertained individually which layer is to be inserted at what time. For this purpose, the links of the directed graph can in particular be specified on a specified set of actions that relate to the selection of individual edges of the directed graph.

The step of determining a reward for the ascertained trajectory can furthermore in each case again take place, for example, in that the architecture represented by the ascertained trajectory is trained based on the labeled training data, wherein the obtained results are subsequently validated or evaluated with regard to the performance with respect to the corresponding specification.

The cost function can in each case also be determined, for example, by determining a flow matching objective. However, the cost function can furthermore also be determined in each case, for example, by determining a detailed balance objective and backward policy or a trajectory balance objective.

The step of respectively updating the flows associated with the edges along the trajectory, based on the cost function can furthermore comprise applying a backtracking algorithm.

The termination criterion can also in each case be selected in such a way that the determination of the corresponding optimal architecture is terminated as soon as a reward ascertained for an ascertained trajectory is within a correspondingly specified target range for the reward, wherein the target range can be different for each of the at least two specifications, for example depending on the importance of the corresponding specification.

The initial flow values can furthermore be selected randomly.

Furthermore, the corresponding strategy for ascertaining an optimal architecture based on the directed graph can be based on the flow values.

According to the embodiments of FIG. 1, for each of the at least two specifications, the strategy for ascertaining a corresponding optimal architecture based on the directed graph in particular specifies, for each node of the directed graph, a probability of the trajectory to be ascertained passing through the corresponding node of the directed graph, wherein the probability is in each case proportional to the flow associated with an edge of the directed graph leading from a previously selected node to the corresponding node, and wherein the trajectory is ascertained by respectively selecting the edge with the highest probability and/or proportionally to the probability.

The strategy moreover specifies that it is additionally also possible at particular times to deviate from the specified probabilities and to follow other edges.

According to the embodiments of FIG. 1, the step 5 of ascertaining an optimal architecture of the artificial neural network based on the respective optimal architectures with respect to each of the at least two specifications comprises a weighted summation of the respective optimal architectures with respect to each of the at least two specifications, or of the ascertained optimal architectures with respect to all of the at least two specifications.

In particular, the optimal architecture of the artificial neural network is ascertained by a weighted summation of the corresponding individual rewards and a weighted summation of the corresponding individual flows.

According to the embodiments of FIG. 1, the weighting is furthermore based on current hardware conditions of at least one target component.

For example, the weightings can be selected in such a way that an energy consumption is minimized, if possible, as soon as the fill level of an energy store of the at least one target component is lower than a threshold value for the fill level.

In particular, the importance or a desired influence of a specification can be varied by appropriately selecting the weighting.

According to the embodiments of FIG. 1, the reward for the trajectory is furthermore also determined based on hardware conditions of at least one target component. For example, the hardware requirements can respectively also be included in the determination of the performance of an artificial neural network trained based on the architecture representing the trajectory and on training data, wherein the hardware properties can be provided with a weighting factor, and wherein the greater this weighting factor is selected, the more the focus is on the hardware requirements.

An optimal architecture ascertained by the method 1 can subsequently be used to train a corresponding artificial neural network based on corresponding labeled training data.

In particular, an artificial neural network can be trained to control a controllable system and be subsequently used to control the controllable system, wherein the controllable system can, for example, be an embedded system of a motor vehicle or functions of an autonomously driving motor vehicle. For example, in the context of partially automated driving, the method can ascertain an optimal architecture of a neural network performing a plurality of tasks.

However, an artificial neural network can furthermore also be trained to classify image data, in particular digital image data, on the basis of low-level features, for example edges or pixel attributes. In this case, an image processing algorithm can furthermore be used to analyze a classification result which is focused on corresponding low-level features.

FIG. 2 shows a schematic block diagram of a system for ascertaining an optimal architecture of an artificial neural network 10 according to embodiments of the present invention.

According to the embodiments of FIG. 2, the system 20 comprises a first provision unit 11 designed to provide a set of possible architectures of the artificial neural network; a representation unit 12 designed to represent the set of possible architectures of the artificial neural network in a directed graph, wherein the nodes of the directed graph respectively symbolize a subset of one of the possible architectures, wherein an initial node symbolizes an input layer, wherein terminal nodes of the directed graph respectively symbolize a subset comprising an output layer, and wherein the edges of the directed graph symbolize possible links between the subsets; a first ascertainment unit 13 designed to respectively ascertain, for each of at least two specifications for ascertaining the architecture, an optimal architecture with respect to the corresponding specification by respectively associating a flow with each edge of the directed graph, defining a strategy for ascertaining a corresponding optimal architecture based on the directed graph, and ascertaining the corresponding optimal architecture by repeatedly ascertaining a trajectory from the initial node to a terminal node based on the defined strategy, determining a reward for the ascertained trajectory, determining a cost function for the ascertained trajectory based on the ascertained reward for the trajectory and the flows associated with the edges along the trajectory, and respectively updating the flows associated with the edges along the trajectory, based on the cost function, wherein the steps of ascertaining a trajectory, of determining a reward, of determining a cost function, and of updating the flows are repeated until an ascertained trajectory fulfills a termination criterion for the architecture search, and wherein the trajectory that fulfills the termination criterion represents the optimal architecture; a second ascertainment unit 14 designed to ascertain the optimal architecture of the artificial neural network based on the respective optimal architectures with respect to each of the at least two specifications; and a second provision unit 15 designed to provide the optimal architecture of the artificial neural network.

The first provision unit can in particular be a receiver designed to receive corresponding data. The second providing unit can in particular be a transmitter designed to transmit corresponding data or information. The first providing unit and the second providing unit can furthermore also be integrated into a common transceiver.

The representation unit, the first ascertainment unit, and the second ascertainment unit can furthermore respectively be realized, for example, based on code that is stored in a memory and can be executed by a processor.

According to the embodiments of FIG. 2, the second ascertainment unit 14 is again designed to ascertain the optimal architecture of the artificial neural network by weighted summation of the optimal architectures with respect to the at least two specifications.

The weighting can again be based on the current hardware conditions of at least one target component.

According to the embodiments of FIG. 2, the first ascertainment unit 13 is moreover again designed to respectively determine the reward for the trajectory based on hardware conditions of at least one target component.

Furthermore, the system 10 can in particular be designed to perform a method described above for ascertaining an optimal architecture of an artificial neural network.

What is claimed is:

1. A method, comprising the following steps:
ascertaining an optimal architecture of an artificial neural network, the ascertaining of the optimal architecture including the following steps:
providing a set of possible architectures of the artificial neural network;
representing the set of possible architectures of the artificial neural network in a directed graph including nodes and edges, wherein the nodes of the directed graph respectively symbolize a subset of one of the possible architectures, wherein an initial node symbolizes an input layer, wherein terminal nodes of the directed graph respectively symbolize a subset including an output layer, and wherein the edges of the directed graph respectively symbolize possible links between the subsets;
respectively ascertaining, for each specification of at least two specifications for ascertaining the architecture, a respective optimal architecture with respect to the specification by respectively associating a flow with each edge of the directed graph, defining a strategy for ascertaining the respective optimal architecture based on the directed graph, and ascertaining the optimal architecture by repeatedly ascertaining a trajectory from the initial node to a terminal node based on the defined strategy, determining a reward for the ascertained trajectory, determining a cost function for the ascertained trajectory based on the ascertained reward for the trajectory and the flows associated with the edges along the trajectory, and respectively updating the flows associated with the edges along the trajectory, based on the cost function, wherein the steps of ascertaining a trajectory, of determining a reward, of determining a cost function, and of updating the flows are repeated until an ascertained trajectory fulfills a termination criterion for the architecture search, and wherein the trajectory that fulfills the termination criterion represents the respective optimal architecture;
ascertaining the optimal architecture of the artificial neural network based on the respective respective optimal architectures with respect to each of the at least two specifications; and
providing the optimal architecture of the artificial neural network.

2. The method according to claim 1, wherein the step of ascertaining the optimal architecture of the artificial neural network based on the respective optimal architectures with respect to each of the at least two specifications includes a weighted summation of the respective optimal architectures with respect to each of the at least two specifications.

3. The method according to claim 2, wherein each corresponding weighting is based on current hardware conditions of at least one target component.

4. The method according to claim 3, wherein the reward for the ascertained trajectory is respectively determined based on hardware conditions of at least one target component.

5. The method according to claim 1, further comprising:
training the artificial neural network, including:
providing training data for training the artificial neural network; and
training the artificial neural network based on the training data and the optimal architecture.

6. The method according to claim 5, wherein the training data include sensor data.

7. The method according to claim 5, further comprising:
controlling a controllable system based on the trained artificial neural network.

8. A system for ascertaining an optimal architecture of an artificial neural network, the system comprising:
a first provision unit configured to provide a set of possible architectures of the artificial neural network;
a representation unit configured to represent the set of possible architectures of the artificial neural network in a directed graph including nodes and edges, wherein the nodes of the directed graph respectively symbolize a subset of one of the possible architectures, wherein an initial node symbolizes an input layer, wherein terminal nodes of the directed graph respectively symbolize a subset including an output layer, and wherein the edges of the directed graph respectively symbolize possible links between the subsets;
at least one first ascertainment unit configured to respectively ascertain, for each specification of at least two specifications for ascertaining the architecture, a respective optimal architecture with respect to the specification by respectively associating a flow with each edge of the directed graph, defining a strategy for ascertaining the respective optimal architecture based on the directed graph, and ascertaining the respective optimal architecture by repeatedly ascertaining a trajectory from the initial node to a terminal node based on the defined strategy, determining a reward for the ascertained trajectory, determining a cost function for the ascertained trajectory based on the ascertained reward for the trajectory and the flows associated with the edges along the trajectory, and respectively updating the flows associated with the edges along the trajectory, based on the cost function, wherein the steps of ascertaining a trajectory, of determining a reward, of determining a cost function, and of updating the flows are repeated until an ascertained trajectory fulfills a termination criterion for the architecture search, and wherein the trajectory that fulfills the termination criterion represents the respective optimal architecture;
a second ascertainment unit configured to ascertain the optimal architecture of the artificial neural network based on the respective optimal architectures with respect to each of the at least two specifications; and
a second provision unit configured to provide the optimal architecture of the artificial neural network.

9. The system according to claim 8, wherein the second ascertainment unit is configured to ascertain the optimal architecture of the artificial neural network by weighted summation of the respective optimal architectures with respect to each of the at least two specifications.

10. The system according to claim 9, wherein each corresponding weighting is based on current hardware conditions of at least one target component.

11. The system according to claim 8, wherein the at least one first ascertainment unit is respectively configured to determine the reward for the trajectory based on hardware conditions of at least one target component.

12. A system for training an artificial neural network, comprising:
a first provision unit configured to provide training data for training the artificial neural network;
a second provision unit configured to provide an optimal architecture for the artificial neural network, wherein the optimal architecture has been ascertained by a system for ascertaining an optimal architecture for an artificial neural network, which includes:
a third provision unit configured to provide a set of possible architectures of the artificial neural network;
a representation unit configured to represent the set of possible architectures of the artificial neural network in a directed graph including nodes and edges, wherein the nodes of the directed graph respectively symbolize a subset of one of the possible architectures, wherein an initial node symbolizes an input layer, wherein terminal nodes of the directed graph respectively symbolize a subset including an output layer, and wherein the edges of the directed graph respectively symbolize possible links between the subsets,
at least one first ascertainment unit configured to respectively ascertain, for each specification of at least two specifications for ascertaining the architecture, a respective optimal architecture with respect to the specification by respectively associating a flow with each edge of the directed graph, defining a strategy for ascertaining the respective optimal architecture based on the directed graph, and ascertaining the respective optimal architecture by repeatedly ascertaining a trajectory from the initial node to a terminal node based on the defined strategy, determining a reward for the ascertained trajectory, determining a cost function for the ascertained trajectory based on the ascertained reward for the trajectory and the flows associated with the edges along the trajectory, and respectively updating the flows associated with the edges along the trajectory, based on the cost function, wherein the steps of ascertaining a trajectory, of determining a reward, of determining a cost function, and of updating the flows are repeated until an ascertained trajectory fulfills a termination criterion for the architecture search, and wherein the trajectory that fulfills the termination criterion represents the respective optimal architecture,
a second ascertainment unit configured to ascertain the optimal architecture of the artificial neural network based on the respective optimal architectures with respect to each of the at least two specifications, and
a fourth provision unit configured to provide the optimal architecture of the artificial neural network; and
a training unit configured to train the artificial neural network based on the training data and the optimal architecture.

13. The system according to claim 12, wherein the training data comprise sensor data.

14. A system for controlling a controllable system based on an artificial neural network, wherein the system comprises:
a provision unit configured to provide an artificial neural network which is trained to control the controllable system, wherein the artificial neural network has been trained by a system for training an artificial neural network which includes:
a first provision unit configured to provide training data for training the artificial neural network;
a second provision unit configured to provide an optimal architecture for the artificial neural network, wherein the optimal architecture has been ascertained by a system for ascertaining an optimal architecture for an artificial neural network, which includes:
a third provision unit configured to provide a set of possible architectures of the artificial neural network;
a representation unit configured to represent the set of possible architectures of the artificial neural network in a directed graph including nodes and edges, wherein the nodes of the directed graph respectively symbolize a subset of one of the possible architectures, wherein an initial node symbolizes an input layer, wherein terminal nodes of the directed graph respectively symbolize a subset including an output layer, and wherein the edges of the directed graph respectively symbolize possible links between the subsets,
at least one first ascertainment unit configured to respectively ascertain, for each specification of at least two specifications for ascertaining the architecture, a respective optimal architecture with respect to the specification by respectively associating a flow with each edge of the directed graph, defining a strategy for ascertaining the respective optimal architecture based on the directed graph, and ascertaining the respective optimal architecture by repeatedly ascertaining a trajectory from the initial node to a terminal node based on the defined strategy, determining a reward for the ascertained trajectory, determining a cost function for the ascertained trajectory based on the ascertained reward for the trajectory and the flows associated with the edges along the trajectory, and respectively updating the flows associated with the edges along the trajectory, based on the cost function, wherein the steps of ascertaining a trajectory, of determining a reward, of determining a cost function, and of updating the flows are repeated until an ascertained trajectory fulfills a termination criterion for the architecture search, and wherein the trajectory that fulfills the termination criterion represents the respective optimal architecture,
a second ascertainment unit configured to ascertain the optimal architecture of the artificial neural network based on the respective optimal architectures with respect to each of the at least two specifications, and
a fourth provision unit configured to provide the optimal architecture of the artificial neural network; and
a training unit configured to train the artificial neural network based on the training data and the optimal architecture; and
a control unit configured to control the controllable system based on the provided artificial neural network.

15. A non-transitory computer-readable medium on which is stored a computer program having program code for performing a method for ascertaining an optimal architecture of an artificial neural network, the program code, when executed by a computer, causing the computer to perform the following steps:
providing a set of possible architectures of the artificial neural network;
representing the set of possible architectures of the artificial neural network in a directed graph including nodes and edges, wherein the nodes of the directed graph respectively symbolize a subset of one of the possible architectures, wherein an initial node symbolizes an input layer, wherein terminal nodes of the directed graph respectively symbolize a subset including an output layer, and wherein the edges of the directed graph respectively symbolize possible links between the subsets;
respectively ascertaining, for each specification of at least two specifications for ascertaining the architecture, a respective optimal architecture with respect to the specification by respectively associating a flow with each edge of the directed graph, defining a strategy for ascertaining the respective optimal architecture based on the directed graph, and ascertaining the optimal architecture by repeatedly ascertaining a trajectory from the initial node to a terminal node based on the defined strategy, determining a reward for the ascertained trajectory, determining a cost function for the ascertained trajectory based on the ascertained reward for the trajectory and the flows associated with the edges along the trajectory, and respectively updating the flows associated with the edges along the trajectory, based on the cost function, wherein the steps of ascertaining a trajectory, of determining a reward, of determining a cost function, and of updating the flows are repeated until an ascertained trajectory fulfills a termination criterion for the architecture search, and wherein the trajectory that fulfills the termination criterion represents the respective optimal architecture;
ascertaining the optimal architecture of the artificial neural network based on the respective respective optimal architectures with respect to each of the at least two specifications; and
providing the optimal architecture of the artificial neural network.
